(19) United States
(12) Patent Application Publication
(10) Pub. No.: US 2008/0048653 A1
(43) Pub. Date: Feb. 28, 2008

(54) Multi-Turn Shaft Encoder

(75) Inventor: Peter George Sanders, Bath (GB)

Correspondence Address: Bradley N Ruben, Suite 5A, 463 First Street, Hoboken, NJ, 07030-1859, US

(73) Assignee: ROTORK CONTROLS LIMITED, Bath (GB)

(21) Appl. No.: 11/632,673

(22) PCT Filed: Jul. 26, 2005
(86) PCT No.: PCT/GB05/02911

§ 371 Date: Jan. 17, 2007

(30) Foreign Application Priority Data
Sep. 2, 2004 (GB) 0419442.9

(51) Int. Cl. G01B 7/30

(52) U.S. Cl. 324/207.25

(57) ABSTRACT

The present invention provides an absolute shaft encoder to measure both the angular position of a shaft from a given radial axis and simultaneously or in sequence to record the number of completed rotations of the shaft passing through a given radial datum axis, the encoder consisting of a first wheel and signal pick up means generating unique incremental signals such that the radial position of the shaft can be recorded and displayed and actions initiated; at least a second wheel providing unique position signals from a further signal pick up; an indexing mechanism operating between the first and second wheels such that the indexing device rotates the second wheel through an angle equal to the angle subtended by each sector at the wheel center wherein, the first wheel is arranged to operate the indexing mechanism whereby for every completed turn of the first wheel the second wheel is indexed two or more times providing two or more position signals to the second wheel's pick up device.

### FIELD OF THE INVENTION

This invention relates to shaft angular position and number of turns absolute encoders. The term “absolute” in this context indicates that each incremental angular position of the shaft and the number of turns from a designated datum are defined by unique coded signals. The invention applies in particular, but not exclusively, to mechanically driven actuators required for operating fluid valves.

### BACKGROUND OF THE INVENTION

In actuators of the type referred to above, the position of the valve operating member can be determined by measuring the number of turns, together with a fraction of a turn, of a shaft in the actuator gear box. The encoder may consist of a number of wheels in the form of discs or drums, the first wheel in the train being attached to, or driven via gearing by the actuator shaft. The next wheel in the train is driven by the first wheel using a reduction drive mechanism and, similarly, further wheels, if present, are driven by similar reduction drive mechanisms operating between adjacent wheels.

The reduction drive mechanism may consist of gear wheels and pinions carrying the usual involute gear teeth or may be in the form of indexing devices such that a driven wheel in the train is held stationary until the adjacent driving wheel is about to complete one revolution from the datum position. The driving wheel's rotation from the end of one revolution to the commencement of the next revolution releases the driven wheel and allows it to be indexed by a small and fixed angular travel. Similar indexing devices are fitted between the remaining wheels in the train, the arrangement being such, therefore, that the small angular travel of each driven wheel records one complete revolution of each adjacent driving wheel.

It will be appreciated that, whilst indexing mechanisms can only operate as a reducing ratio drive between the driving and driven wheels, the involute gearing drive may be used to provide either a step-down or a step-up ratio between the driving and driven wheels. Step-up ratios may be required in applications using slow speed gear box shafts in order to obtain lower minimum discriminating angle measurements on the shaft than can be obtained with a single, direct driven, encoder wheel.

The wheels are provided with means whereby their angular positions can be recorded. This may be achieved by dividing up the wheels into sectors, the angle subtended by each sector corresponding to the small fixed indexing angles and each sector is provided with coding means such that pick up devices attached to the encoder housing enable each sector in any one wheel to be recognised as the sector traverses the pick up position. The coded tracks on each wheel are normally arranged to emit digital signals via the pick up devices using either magnetic or optical means; but the improvements, the subject of this invention, can be employed with any signalling means which enables coded signals to be produced by the pick up devices using wheels which can rotate and in which the wheels' rotational travel from datum positions is designated by the said pick up devices. In particular, when using signals generated by varying magnetic fields, a very compact design is possible by modifying the foregoing arrangements, replacing the rotating wheels and their coded sectors by rotating permanent magnets and having the magnet poles passing over static Hall sensors incorporated in printed circuit board mounted chips.

The first wheel in the train, which is attached to or driven by the actuator shaft is divided up into a number of equal sectors. The coding means on each sector is arranged to activate the pick up device as the sector passes adjacent to the device, the arrangement therefore being such that the minimum angular discrimination which can be measured and recorded by the first wheel is equal to the small fixed rotation angle occupied by each sector.

In multi-wheel encoders of the type described the sector angles need not be the same on each wheel but it is more convenient and economic to have a common design for the set of wheels in any one train. For example an encoder to record the radial position of a shaft and the number of turns from a fixed datum, using three wheels each wheel being divided up into 16 equal sectors will be able to “count” a total of 256 completed turns of the first incremental wheel and will also be able to discriminate the position of the first incremental wheel to an accuracy of one sixteenth of a turn or 22.5 degrees. A three wheel encoder of this type is able, therefore, to indicate a total of 16×16×16=4096 unique positions.

It should be noted that, if the encoder used in the foregoing example is wired up to show the unique positions of a shaft in the form of a decimal display, the total “count” will be only 4095 before the display then returns to zero. This of course represents 4096 unique shaft positions because the zero datum, designated “0” represents a real position of the shaft in this context.

In practice, because of the binary nature of the software associated with the coding circuits, it is usual to keep to powers of two for the wheel sector numbers: a typical number would be 64 sectors per wheel which gives a minimum angular discrimination of 5.625 degrees on the first incremental wheel.

In existing designs of multi-wheel absolute encoders there exists a problem at the change over period as each driven wheel in the train rotates over the datum axis at which it registers a turns count by the adjacent driving wheel. This can occur particularly in situations where the shaft radial position and the number of turns need to be registered when the shaft is stationary and happens to have come to rest with one or more wheels just about to register a turn or having just registered a turn of the previous driving wheel in the train. The angular tolerances and backlash in the train may cause a small radial gap to exist between the signals being generated by the adjacent wheels. If the shaft comes to rest with one or more wheel change over radii positioned within this radial tolerance gap the recorded count may be in serious error because any one wheel in the train except the first incremental wheel may be recording a one turn error.

Of course, once the shaft is rotating, these errors become transient and can be eliminated to some extent by the associated software. Means exist for reducing or eliminating the position reading errors for a static shaft in situations where no previous shaft operating data, or memory facilities exist; but these means are generally concerned with increasing the accuracy of the mechanical drive devices and with the form and actions of the actual signal generated by the emitting means and related to a single sector of an encoder wheel.

It is an object of the present invention to reduce the need for highly accurate gearing or indexing mechanisms between the wheels in the encoder train. A further object is to reduce the complexity of the emitting signals and the associated software.

### SUMMARY OF THE INVENTION

According to a first aspect of the present invention there is provided an absolute shaft encoder to measure both the angular position of a shaft from a given radial axis and simultaneously or in sequence to record the number of completed rotations of the shaft passing through a given radial datum axis, the encoder comprising: a first wheel and signal pick up device such that rotation of the first wheel generates unique signals defining the number of sectors of the first wheel which have passed over a given radial datum position such that the radial position of the shaft can be recorded and displayed and actions initiated; at least a second wheel and signal pick up device such that rotation of the second wheel generates unique signals defining the number of sectors of the second wheel which have passed over a given radial datum position of the second wheel; and a drive mechanism to operate between the said first and second wheels and arranged so that rotation of the first wheel from the radial datum position over one full turn of the first wheel causes the second wheel to rotate through an angle equal to the angle occupied by at least two sectors of the second wheel.

The unique signals will generally be incremental (and/or decremental) in nature.

In one particularly preferred arrangement the invention provides an absolute shaft encoder where the inter wheel drive mechanism is an indexing mechanism provided to operate between the said first and second wheels and arranged, in use, such that each indexing operation of the indexing device rotates the second wheel through an angle equal to the angle subtended by each sector at the wheel centre and the first wheel is arranged to operate the indexing mechanism in such a manner that for every completed turn of the first wheel the second wheel is indexed at least two times providing at least two position signals to the second wheel's pick up device.

Thus, in one aspect of the present invention two or more sectors on each driven wheel of an absolute shaft encoder serve to indicate, via the associated software, the completion of a single turn on the adjacent driving wheel.

Whereas the use of at least two sectors on each driven wheel in order to indicate a completed turn on the adjacent driving wheel means leads to the total count which can be recorded by a driven wheel being at most half the number of sectors on that wheel, we have realised that this loss in counting range is more than offset by attendant advantages.

The new configuration gives the ability to employ a stack of discrete single wheel shaft encoders complete with their signal pick up means and to couple up these individual encoder units with only modestly accurate indexing or gearing means. The outputs from each encoder wheel in the stack can then be collected and processed in a software package which contains the necessary recording options, the nature of these options being that, at intervals during the rotation of each driven wheel, two or more alternative code combinations from two or more alternative sectors on each driven wheel are used to define a turn of the adjacent driving wheel in the train.

Preferably all wheels together with associated signal pick up devices, position coding means and inter-wheel driving mechanisms are of the same form and configuration, ie the wheels are, for example, all 64 sector wheels and their associated signal pick up devices are of a common type. This allows for substantial economies to be had in the manufacture of the encoders, using multiples of standard parts.

The use of two or more sectors to indicate a turns count means that the critical situation arising when a driving wheel comes to rest with the dividing radius between the two sectors defining a finish and start of a turn, the said radius being either just in front or just behind the change over datum axis, can be avoided.

Furthermore, as will be explained, with two or more sectors on a driven wheel being used to define a turns count on the adjacent driving wheel, it is possible to arrange the indexing or gearing drive between two adjacent wheels so that sector signals from the driven wheel which are defining the turns count of the driving wheel always change over at a time when the critical sectors on the driving wheel which complete and initiate a turns count are not passing through that part of their circumferential travel where signals are being transmitted to the pick up device.

When describing the wheels in the train the terms “driving” and “driven” have been used. The nature of the train of wheels is such that only the first incremental driving wheel and the last driven wheel in the train can have unique descriptions: the other intermediate wheels are both driving and driven. In this context, when describing the actions of a pair of wheels in the train, the wheel which is having it's turns counted is called the driving wheel and the adjacent wheel which is generating the turns count is called the driven wheel.

### BRIEF DESCRIPTION OF THE DRAWINGS

A preferred embodiment of the invention will now be described, by way of example, with reference to the accompanying drawings and tables in which:

FIG. 1 is a diagram showing the first and second wheels of an encoder, the subject of the invention, the wheels being rotationally coupled by an indexing mechanism

FIG. 2 is a table illustrating the typical relative wheel sector positions as the first wheel is rotated over two turns anti-clockwise from the datum position as shown in FIG. 1.

FIG. 3 is a summary table showing one complete cycle of all the possible sector positions possible with two wheels, each having sixteen sectors and coupled by an indexing drive as shown in FIG. 1.

FIG. 4 shows a pictorial view of a typical four wheel encoder assembly embodying the invention.

FIG. 5 shows an improved indexing arrangement between any two encoder wheels in a train of two or more such wheels.

### DESCRIPTION OF THE PREFERRED EMBODIMENT

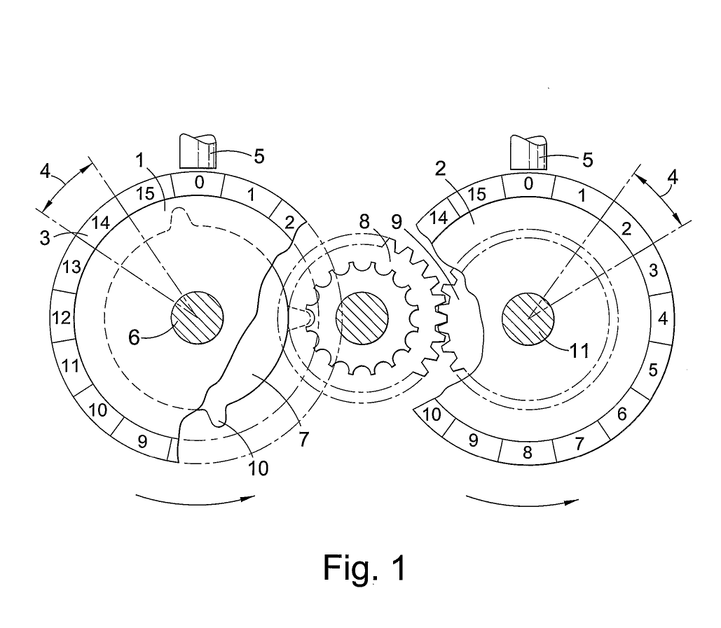

Referring to FIG. 1, the first incremental driving wheel 1 and the adjacent driven wheel 2 are each divided up into sixteen equal sectors, each sector 3 representing that part of the wheel circumference, subtending the discriminating angle 4, which is enabled to emit a discrete coded signal to the pick up devices 5 adjacent to each wheel. The shaft 6 driving the first wheel 1 also operates the indexing mechanism 7 which is arranged to index the second wheel 2 via the gear wheels 8 and 9 as illustrated. The indexing drive between the two wheels is so arranged that the trip mechanisms 10 provide two separately spaced rotational movements of wheel 2 for every completed turn of wheel 1. The angular rotation imparted to the second wheel is equal to the sector angle 4 on that wheel so that, with two indexing operations per one revolution of wheel 1 in this example, eight completed turns of wheel 1 will cause wheel 2 also to complete one revolution returning both wheels to their datum positions.

The indexing mechanism employed can be of any known design on condition that it is capable of providing more than a single indexing operation for every completed turn of the driving member and provided that the driven member does not move (suitably is locked) between successive indexing operations of the mechanism.

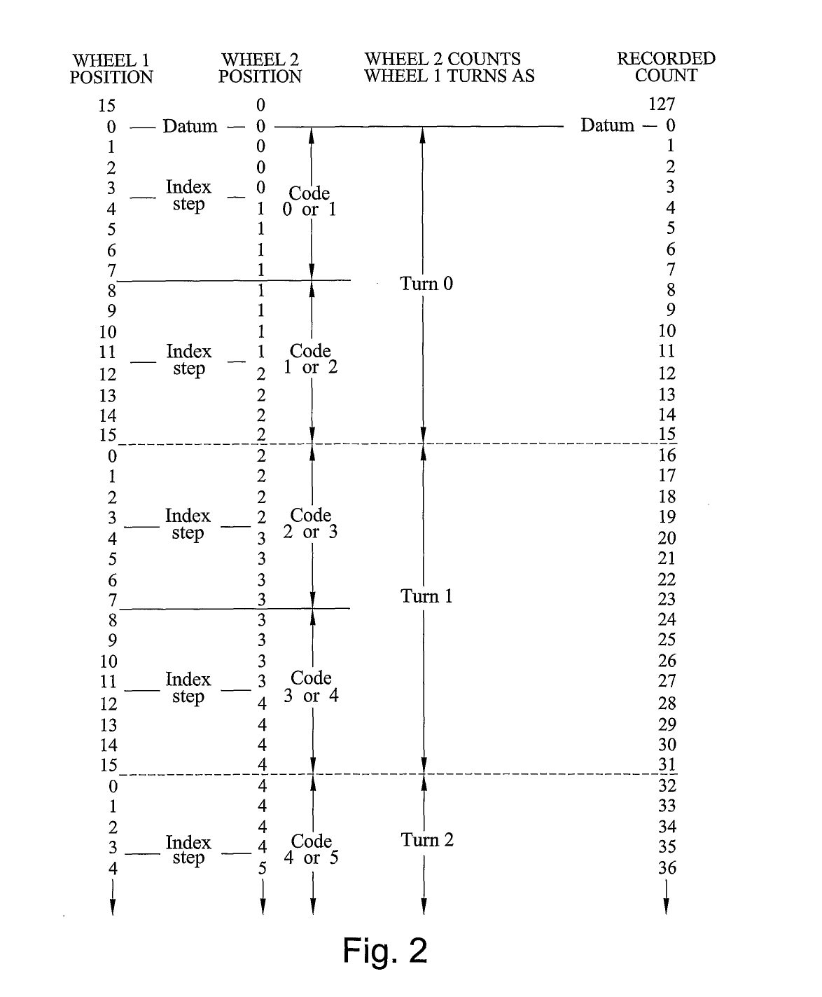

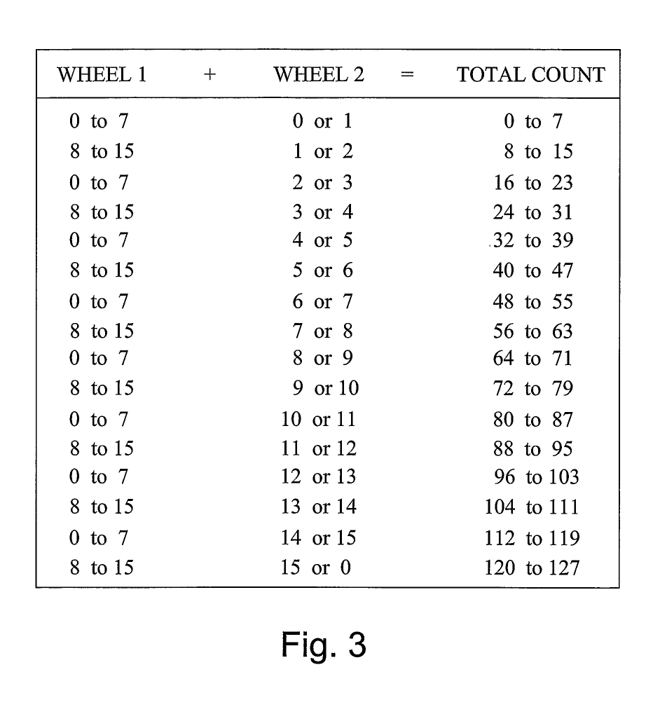

In FIG. 1 the wheel sectors 3 have been given digits numbering clockwise zero to fifteen, the zero digit being adjacent to the pick up on each wheel. This is a convenient way of denoting the individual coded signals being emitted by each wheel: the digits do not necessarily represent a sequential measurement of rotation angles but are used in the Tables of FIGS. 2 and 3 to illustrate the unique combinations of signals which can be obtained and from which the associated software can derive the absolute angular position and the number of turns completed from the radial datum by the first wheel's shaft 6.

FIG. 1 shows just two wheels with their connecting index drive mechanism and with a relatively low number of sectors per wheel in order to simplify the diagram. As previously stated, a more practical number of sectors per wheel is sixty four and with the wheels numbering three or more complete with the indexing and gear drive between adjacent pairs of wheels in the train. In this practical case the shaft 11 on which wheel 2 is mounted will also be provided with the trip mechanism to index a third wheel and similarly up to the last pair of wheels in the train.

FIG. 2 is a tabulated illustration of the operation of the two wheel encoder as shown in FIG. 1, the first driving wheel imparting two indexing operations per turn to the driven wheel 2. The two left hand columns, reading downwards, show the relative positions of each sector as it passes through the signalling zone of the pick up device and in so doing the combined signals register a unique count shown in the right hand column. The table covers just over two completed turns of the first incremental wheel as shown in the right hand column.

Referring back to FIG. 1, the indexing trip mechanisms 10 on wheel 1 shaft 6 have been positioned so that the indexing operations take place when wheel 1 sectors 3 & 4 and 11 & 12 are passing through the signalling zone of the pick up 5. These positions ensure that the two indexing operations on wheel 2 shaft 11 do not take place whilst the critical sectors 15 & 0 on wheel 1 are passing through the signalling zone. The trip positions described in this example are the optimum positions giving equal radial distances between the critical 15 & 0 sectors but it should be understood that any other radial positions for the indexing operations are possible provided that the said operations do not take place at the same time as sectors 15 & 0 of wheel 1 are passing through the signalling zone.

In the example demonstrated in FIG. 2 the change over instruction to the software will be arranged to occur between sectors No. 7 & 8, say, on wheel 1 but the actual radial position is not important provided that it is clear of the sectors involved in the mechanical indexing operations on wheel 2. Examples of the software instructions can be stated in words as follows:

Wheel 1 on 8 to 15 & Wheel 2 on 1 or 2 corresponds to Combined Count=8 to 15

Wheel 1 on 0 to 7 & Wheel 2 on 2 or 3 corresponds to Combined Count=16 to 23

Wheel 1 on 8 to 15 & Wheel 2 on 3 or 4 corresponds to Combined Count=24 to 31

For the two wheels used in the foregoing examples the complete cycle of position reading operations before the wheels are returned to their datum positions is illustrated in the Table of FIG. 3. This table shows that, for two sixteen sector wheels with the indexed second wheel operated twice for every turn of the incremental driving first wheel, the total number of unique coded positions which can be recorded is:
16×8=128

It should be obvious that the arrangements used for the first pair of wheels can be extended to any additional number of wheels, adjacent pairs of wheels in the train being connected by indexing drives as for wheels 1 and 2. Each wheel and index mechanism, when added to the original pair of wheels, will multiply the available designated shaft positions by a factor equal to one half of the sectors on the added wheel.

For small compact multi-wheel encoder assemblies using high numbers of sectors per wheel it is sometimes convenient to arrange for the indexing mechanism to advance each driven wheel by more than one sector per step when the mechanical tolerances in the indexing mechanism and gears may be too large to index a driven wheel to within the precise signal zone of one sector. For example, using a standard sixty four sector wheel with four such wheels in the train, the first incremental wheel can be used to signal all of it's sector positions and the remaining indexed driven wheels in the train can be advanced two sectors per indexed operation. With two indexing operations per turn of the first wheel this arrangement will give a total number of unique coded positions equal to:
64×16×16×16=262144

The various possible numerical arrangements may be covered by three general mathematical statements which generally have to be conformed to in order to ensure that the features described in the Tables of FIGS. 2 and 3 and with additional wheels added to the train remain in the same relative positions over the whole counting range of the assembled wheels. These are:

1. The number of sectors in each wheel, except the first incremental wheel, must be an exact multiple of the number of sectors advanced by each indexing operation on that wheel.

2. The number of sectors in any driven wheel must be an exact multiple of the product of the number of sectors advanced by each indexing operation and the number of indexing operations performed on the said driven wheel by the adjacent driving wheel during one complete turn of the driving wheel.

3. In the case of an encoder train of wheels driven by gears in place of the indexing mechanisms, the number of sectors in any driven wheel must be an exact multiple of the gear ratio expressed as a whole number the said ratio being equal to or less than half the number of sectors in the driven wheel.

As an example of the third condition, the sixty four sector wheel train can employ ratios of 32:1, 16:1 or 8:1. Ratios below 8:1 are theoretically possible but impractical.

The various foregoing statements and conditions governing the number of unique coded positions that can be recorded may be stated in mathematical terms as follows:
n=The number of sectors on each encoder wheel.
a=The number of encoder wheels in the train.
b=The number of sectors advanced on each driven wheel by the indexing mechanism being operated by the adjacent driving wheel.
c=The number of indexing operations completed for one turn of each driving wheel.
y=The total number of unique coded positions which can be recorded by the wheels in the train.
Then:

$$y = n ⨯ {[ \frac{n}{b ⨯ c} ]}^{( a - 1 )}$$

In the above equation the following conditions apply:
All symbols represent whole positive numbers.
The number c>=2 (c must be greater than or equal to two).
The fraction n/b×c must equal a whole number.

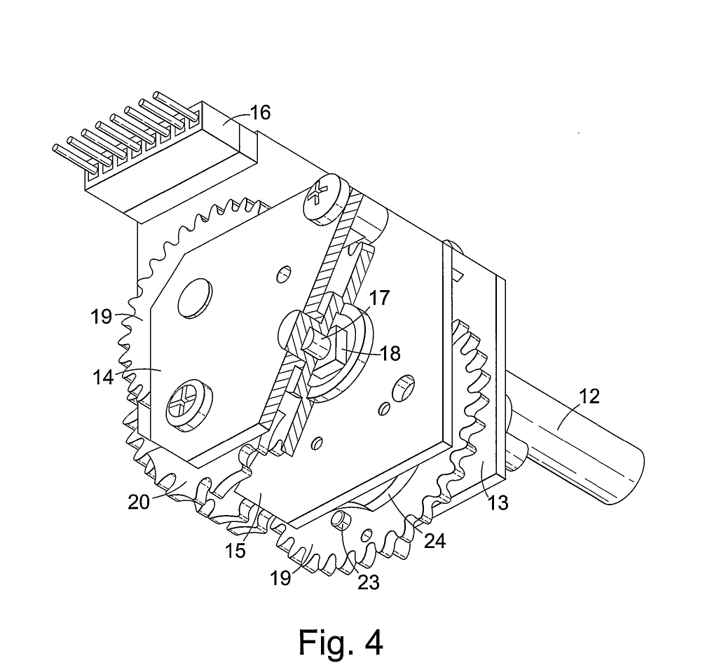

FIG. 4 shows a part sectioned pictorial view of a four wheel absolute shaft encoder assembly. In this assembly the input shaft 12, is supported in bearings carried in the lower plate 13 and the intermediate plate 15. The upper plate 14 and the other two plates are bolted or otherwise securely assembled together with spacers forming two gaps, one on each side of the intermediate plate 15, between which the encoder components with the drive mechanisms are mounted.

The intermediate plate 15 is in the form of a printed circuit board, one extended side forming a platform for a multi-pin plug and socket connector 16.

The particular absolute shaft encoder illustrated in the part sectioned view on FIG. 4 is of the type using a rotating magnet 17 which forms the wheel of the encoder and which passes over a Hall sensor array 18 mounted on the printed circuit board acting as the intermediate plate 15. Both sides of the printed circuit board may be used for mounting the Hall sensor arrays 18 together with some or all of the associated electronic components required for the coding process. In the assembly illustrated in FIG. 4 the drive between adjacent rotating magnets 17 in the four wheel train uses both spur gears 19 and indexing devices 20. The three drives required to couple up the four rotating magnets are of the same form as illustrated diagrammatically in FIG. 1.

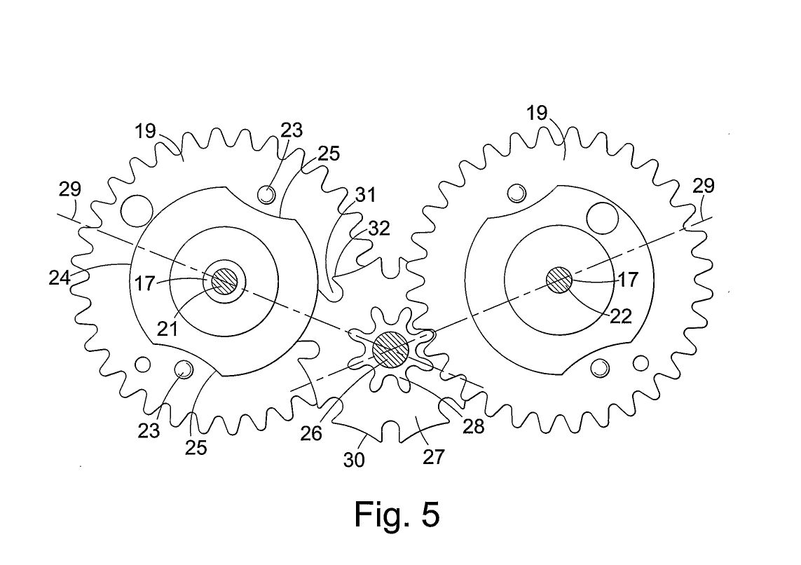

Referring now to FIG. 5, this shows an improved indexing arrangement which can be fitted between any two wheels of the encoder assembly. The example illustrated is depicted as an extended view of two adjacent wheels contained in the typical assembly in FIG. 4.

The two magnets 17 are rotated on the centres 21 and 22 together with the gear wheels 19. Mounted on these gear wheels are two circular pegs 23 which correspond to the trip mechanisms 10 illustrated in diagrammatic form in FIG. 1. Integral, or fitted to each gear wheel 19 is a raised circular register 24 which is provided with cut outs 25 in the region of each circular peg 23.

Between the two encoder centres 21 and 22 is a fixed shaft 26 on which rotates the index wheel 27 integral or attached to a pinion gear wheel 28. It will be appreciated that the angle made by the two centre lines 29 passing through the three turning centres may be smaller or larger than that shown in FIG. 5 and, in particular, a smaller angle can be used allowing the two gear wheels 19 to overlap provided they are rotated in different planes as illustrated in FIG. 4.

In describing the operation of the indexing mechanism and using the aforementioned terminology, gear 19 on centre 21 is the driving gear and gear 19 on centre 22 is the driven gear. In the position as illustrated the index wheel 27 is being held in a fixed radial position by the cooperating surfaces of the raised circular register 24 and one of the concave shaped surfaces 30 of the index wheel 27.

From this position rotation of the driving gear wheel 19 on centre 21 will cause a circular peg 23 to enter a slot 31 on the index wheel 27. Further rotation of the driving shaft will cause the index wheel to rotate as the circular peg's surface cooperates with the side of the slot 31. The length of the circular path of the peg 23, whilst co-operating with the slot 31, is so arranged that the pinion gear wheel is rotated through an angle equal to one tooth pitch and so driving the meshing gear wheel 19 on the centre 22 by a corresponding one tooth pitch. The cut outs 25 on the register 24 are so shaped that the corners 32 of the index wheel 27 are able to pass through these cut outs whilst the index wheel is being driven by a circular peg.

The complete operation of the indexing mechanism is, therefore, such that a single turn of the driving gear wheel on centre 21 will cause two separate indexing cycles to take place on the index wheel 27 and so transmit, via the pinion gear wheel 28 and the meshing gear wheel 19, two separate indexing operations on the rotating magnet 17 on centre 22.

A feature of the indexing mechanism which reduces backlash between adjacent wheels in the train and so enables the indexing components to be made using only moderately accurate cooperating components is the position of the engaging region where a concave shaped surface 30 of the index wheel 27 is cooperating with the raised circular register 24. In this engaging region where the overlapping index wheel 27 is being held stationary between indexing operations, the angular backlash of the index wheel due to spatial tolerances between the cooperating surfaces is an approximate direct relationship to the outside diameter of the index wheel. Because the two wheels 19 and the index wheel 27 all rotate in separate planes their outside diameters are able to overlap. It is this overlapping feature which allows the index wheel outer diameter to be a significant size, so enabling the backlash, when in non-rotating mode, to be controlled to a sufficiently low value to hold each driven wheel sector within the allowable signalling zone of the pick up device.

Further Software Features

In applications where a multi-wheel shaft encoder is being used to obtain a unique set of signals defining the linear or radial positions occupied by a shaft it may be necessary to provide a warning signal that a mechanical failure has occurred in the drive mechanisms being used to operate the individual gears and wheels which make up the encoder assembly. This is particularly the case in Valve Actuator Technology where the positions of the valve moving elements may not be visible and the mechanical failure occurs at or towards the end of one valve operation cycle followed by the switching off of power supplies to the actuator

In this situation, particularly when the actuator is installed in a hazardous site, it may be necessary to have an immediate warning signal of the mechanical failure as soon as power is restored and before a command signal is made to commence another valve operation cycle.

The electronic software associated with the absolute multi-wheel shaft encoder is designed to generate a sequential series of coded signals which, apart from the one situation where the shaft moves across the encoder wheels' zero datum position, are arranged to differ by a constant number—usually by plus or minus one if the signals are displayed as numbers to base 10.

The most likely time that a failure will occur in the drive mechanism linking any two encoder wheels in the train is when the said drive mechanism is being operated. This will result in loss of continuity in the constant one or more incremental counts being generated. An addition to the basic software can, therefore, be made to monitor the continuity of the count being generated and to operate a failure signal when the continuity is disturbed. Depending on the type of duty required by the actuator, the signal can be used to display a warning only; to display a warning and to shut down the actuator or, in the latter case, to allow the actuator to complete its current operating cycle, or one further cycle to terminate at a safe parked position and then shut down the actuator and call for service attention.

An example of this last situation occurs in valve operations where the specification is such that a failure of the control system requires that the valve automatically moves to a “fail safe” parked position—usually to either the fully closed or fully open states even though the positional count will have been lost the actuator can be allowed to move under power to an end of travel position where power to the drive motor will be switched off by operation of the torque limit switches.

In installations where the safety requirements are such that the power has been switched off and the actuator must not be restarted once a warning circuit has been activated it will be necessary to provide the warning signal in the form of a non-volatile memory which is re-activated as soon as power is restored prior to attempting a new operation cycle.

The scanning signal required to check the continuity of the count being generated is arranged to operate in the small time interval, typically 5 to 10 milliseconds between successive counts and compares the total count value with the previous count total value. In applications where the normal working rotations of the shaft cause the encoder assembly wheels to traverse the encoder zero datum position, the software logic which is checking the continuity, of the count must be such that it is able to recognise that, on a positive count (numbers increasing in value), the unique number which immediately precedes the zero signal does not indicate a discontinuity. A feature of the software for the absolute encoder assembly so far described is that the warning signal can only be activated once a failure in the counting sequence has been recorded. This means that even if the actuating cycle is stopped immediately, by the action of the warning signal, the position of the actuating shaft will be lost on the monitoring circuit and display unless special retaining memory features are added to the control and monitoring systems external to the actuator or other machinery.

A special feature of the present invention is that this loss of recorded position, due to a mechanical failure of the indexing mechanism, can be eliminated by making use of the fact that the actual recorded count generated by the encoder assembly driven wheels occurs after a small interval of time from the completion of each indexing operation. This can be understood by reference to the example displayed in FIG. 2 where the indexing operations on the driven wheel 2 always occur at or about the incremental driving wheel 1 positions 3 and 4 or 11 and 12 whereas the actual change in the count due to wheel 2's rotation is delayed until wheel 1 moves over the datum position zero to 15 or 15 to zero depending on the direction of rotation of the wheel 1.

The addition to the actuator software logic, again referring to the wheel notations on FIG. 2 will be of the form: “When driving wheel 1 positions 3 and 4 or 11 and 12 passes over the pick up area the driven wheel 2 must execute an indexing operation which Will be recorded by wheel 2 pick up.” This requirement can be repeated in a multi-wheel encoder consisting of more than two wheels, the condition applying to any pair of adjacent driving and driven wheels in the train. A failure to adhere to this requirement may be arranged to activate a failure signal; such a signal will be, in effect, warning that the position count will be lost following an interval of time which will expire when any driving wheel in the train which has failed to index the adjacent driven wheel passes over its datum position. Importantly, the interval can be used to store the position at which the warning was issued as well as initiating the other actions needed to deal with the failure.

1. An absolute shaft encoder to measure both the angular position of a shaft from a given radial axis and simultaneously or in sequence to record the number of completed rotations of the shaft passing through a given radial datum axis, the encoder comprising: a first wheel and signal pick up device such that rotation of the first wheel generates unique signals defining the number of sectors of the first wheel which have passed over a given radial datum position such that the radial position of the shaft can be recorded and displayed and actions initiated; at least a second wheel and signal pick up device such that rotation of the second wheel generates unique signals defining the number of sectors of the second wheel which have passed over a given radial datum position of the second wheel; and a drive mechanism to operate between the said first and second wheels and arranged so that rotation of the first wheel from the radial datum position over one full turn of the first wheel causes the second wheel to rotate through an angle equal to the angle occupied by at least two sectors of the second wheel.

2. An absolute shaft encoder according to claim 1 in which for each of the first and second wheels the relative radial positions of the respective pick up device and sectors are so arranged that the sequential change from one sector's unique signal made by the pick up device which records the second wheel's radial positions does not take place while the sector of the first wheel that defines the completion of a turn of the first wheel is passing through the operational zone of the signal pick up device for the first wheel.

3. An absolute shaft encoder according to claim 1 in which said drive mechanism is an indexing mechanism so arranged that for every completed turn of the first wheel the second wheel is indexed two or more times; each indexing operation turns the second wheel through an angle equal to the angle occupied by one sector of the second wheel such that one completed turn of the first wheel provides two or more position signals from the second wheel's pick up device.

4. An absolute shaft encoder according to claim 1 in which said drive mechanism is a gear train, the gear ratio between said first and second wheels being a whole number and whereby one completed turn of the first wheel turns the second wheel through an angle equal to the angle occupied by at least two sectors of the second wheel and so providing two or more position signals from the second wheel's pick up device.

5. An absolute shaft encoder according to claim 1 further comprising processing means for processing the signals from the first and second wheels, the processing means being configured so that in a combined signal indicating the radial position of the first wheel and the number of turns of the first wheel a single turn of the first wheel is denoted by more than one coded signal generated by the second wheel and indicating that one wheel sector of a number equal to two or more sectors of the second wheel is in the operating zone of the pick up device.

6. An absolute shaft encoder according to claim 1 in which additional wheels and pick up device sets are added to the assembly in a train and additional drive mechanisms are placed between the wheels so that each additional wheel in the train following said first and second wheels is driven round by a wheel immediately preceding it in the train in the above-defined manner in which the second wheel is driven by the first wheel.

7. An absolute shaft encoder according to claim 1 in which the first and second wheels and any said additional wheels are in the form of discs.

8. An absolute shaft encoder according to claim 1 in which first and second wheels and any said additional wheels generating the coded position signals are in the form of closed or open ended drums with code generating means contained on or within the cylindrical surfaces of the drums.

9. An absolute shaft encoder according to claim 1 in which the first and second wheels and any said additional wheels generating the coded position signals are in the form of rotating magnets the poles of the magnets passing over or adjacent to pick up devices sensitive to magnetic fields such that unique signals are generated corresponding to incremental (and/or decremental) sectors of the wheels, each unique signal depending upon the relative radial positions of the poles of the said magnets and the pick up devices.

10. An absolute shaft encoder in accordance with claim 1 in which all wheels together with associated signal pick up devices and position coding means and the inter-wheel driving mechanisms are of the same form and configuration.

11. An absolute shaft encoder in accordance with claim 6 in which the wheels of each set together with their individual signal pick up means and position coding means are individually contained within a respective separate housing, the shafts on which the wheels are mounted being extended to pass through each housing, the housings being mounted on a sub-frame on to which are also mounted the drive mechanisms to enable the single wheel shaft encoders to be operated in a train by a multi-turn input shaft.

12. An absolute shaft encoder in accordance with claim 1 in which the wheels, wheel shafts and signal pick up device sets are mounted on a common sub-frame.

13. An absolute shaft encoder in accordance with claim 12 in which the common sub-frame is a printed circuit board and the signal pick-up devices are in the form of electronic chips that are mounted directly on the printed circuit board.

14. An absolute shaft encoder in accordance with claim 13 in which the printed circuit board contains, or has mounted thereon, processing means to carry out some or all of the processing of the signals produced by the encoder wheels.

15. An absolute shaft encoder as claimed in claim 1, having successive encoder wheel assemblies in a train and in which the drive between each of the successive encoder wheel assemblies comprises a combination of meshing gear wheels and an indexing mechanism mounted on a separate shaft between the driving and driven wheel centres; the indexing mechanism comprising a gear which meshes with a driven gear wheel and an index wheel; a circular register mounted on or integral with a driving gear wheel the register being provided with at least two cut outs and co-operating with concave shaped surfaces on the outermost diameter of the said index wheel; at least two substantially circular pegs mounted on or integral with the driving gear wheel the said pegs cooperating with slots cut into the index wheel; wherein the two successive encoder gear wheels and the index wheel all rotate in separate substantially parallel planes and the cooperating surfaces of the index wheel rotate on a diameter which overlaps the outside diameters of the driving and driven gear wheels.

16. An absolute shaft encoder assembly according to claim 1 which in use and in association with the processing means/software provided to determine the radial or linear position of a shaft is configured to enable or cause a warning circuit to be activated in the event that a mechanical fault occurs in the mechanisms driving the encoder wheels.

17. An absolute shaft encoder assembly according to claim 16 which in use generates a series of position signals in the form of an increasing or diminishing series of numbers the difference in value between successive position signals being a constant incremental (or decremental) number having a minimum value of one, characterised in that a scanning operation is provided in the associated processing means/software which is activated following each counting operation and terminated prior to the next counting operation the scanning operation being such that a warning circuit is activated if the increment (or decrement) between the immediate and the penultimate counts is different from the said constant incremental (or decremental) number.

18. An absolute shaft encoder assembly according to claim 17 in which in use the shaft is able to move through the position at which the encoder records a zero count the associated processing mean/software logic being so arranged that the incremental (or decremental) value between the signals indicating the zero number and the unique number coming prior to the zero number shall be recognised by the processing means/software as the same number as the unique constant incremental number between any other pair of successive counts.

19. An absolute shaft encoder assembly according to claim 17 in which the warning signal indicating a discontinuity in the count being generated to measure the movement of a shaft is in the form of a non-volatile memory whereby the status of the said signal is maintained when all power supplies to the encoder assembly and to the motor driving the said shaft have been switched off.

20. An actuating system being monitored and controlled by an absolute shaft encoder assembly according to claim 19 in which the warning signal indicating that a fault has occurred during a previous operating cycle is re-activated as soon as power is restored to the actuating system the said signal being available to prevent a further operation of the actuating system if so required.

21. An absolute multi-wheel shaft encoder according to claim 1 in which processing means/software is provided to generate a warning signal of an impending loss of the count due to the mechanical failure of the encoder assembly that defines the radial position and the number of turns from a datum position of the shaft which is driving the first wheel of the train of wheels of the encoder assembly.

22. An absolute multi-wheel shaft encoder according to claim 21 in which a said drive mechanism is provided between adjacent wheels in the train; the position sensing pick up devices and the wheel drive mechanisms are so arranged that two or more said unique signals are initiated by the driving wheel of any co-operating pair of wheels in the train the said signals occurring in advance of a second signal which records the successful completion of a rotation on the driving wheel of the said pair of wheels; the interval between the said two or more signals and the said second signal is used to check that the operations to which the two or more signals correspond have been completed, a failure to complete a said operation being recorded prior to the loss of the position count due to the said failure, associated processing means/software being arranged to store the value of the position count at the first recorded failure.
